(19) United States
(12) Patent Application Publication
(10) Pub. No.: US 2021/0059306 A1
(43) Pub. Date: Mar. 4, 2021

(54) AEROSOL-GENERATING DEVICE AND SYSTEM

(71) Applicant: SHENZHEN YUYAN INDUSTRIAL LIMITED, Shenzhen (CN)

(72) Inventors: BIN CHEN, Shenzhen (CN); YONG-HUI LIN, Shenzhen (CN)

(21) Appl. No.: 17/082,004

(22) Filed: Oct. 27, 2020

Related U.S. Application Data
(63) Continuation of application No. PCT/CN2019/084817, filed on Apr. 28, 2019.

(30) Foreign Application Priority Data
Apr. 28, 2018 (CN) 201810401902.4

(51) Int. Cl. A24F 40/40; A24F 40/50

(52) U.S. Cl. CPC A24F 40/40; A24F 40/50

(57) ABSTRACT

The present application provides an aerosol-generating device including a housing and a magnetic element. The housing defines an accommodating cavity capable of accommodating an aerosol-generating article. The magnetic element is disposed in the accommodating cavity and capable of generating magnetic attraction or magnetic repulsion to the aerosol-generating article to draw or push the aerosol-generating article towards a predetermined location of the accommodating cavity or in a predetermined direction. The present application also provides an aerosol-generating system including the aerosol-generating device and an aerosol-generating article. The aerosol-generating article includes an element that is capable of being attracted by the magnetic attraction or repelled by the magnetic repulsion.

### CROSS-REFERENCE TO RELATED APPLICATIONS

This application claims priority of China Patent Application No. 201810401902.4, filed on Apr. 28, 2018, entitled “AEROSOL-GENERATING DEVICE AND SYSTEM”, the content of which is hereby incorporated by reference in its entirety. This application is a continuation under 35 U.S.C. §120 of international patent application PCT/CN2019/084817, filed on Apr. 28, 2019, the content of which is also hereby incorporated by reference in its entirety.

### TECHNICAL FIELD

This application relates to aerosol-generating devices and aerosol-generating systems.

### BACKGROUND

A conventional electronic cigarette is mainly composed of an atomizer, a battery, and a mouthpiece. The battery provides electric power to heat an electric heating wire of the atomizer. The electric heating wire is usually wrapped with a wick. Two ends of the wick are disposed into an e-liquid reservoir. When the reservoir is filled with e-liquid, the wick draws the e-liquid to the electric heating wire. As the temperature of the electric heating wire rises, the e-liquid in the wick is heated and vaporized to form smoke, which is then inhaled by the consumer through the mouthpiece. Since no combustion occurs in the electronic cigarette, harmful substances such as CO and tar is reduced, which greatly alleviates harmful effects of second-hand smoke.

A low-temperature heated cigarette is also called a heat-not-burn cigarette, which is commonly in shape of a traditional cigarette, but unlike the traditional cigarette, the low-temperature heated cigarette generates smoke by heating rather than combustion. That is, the low-temperature heated cigarette designed with the idea of “heat-not-burn” may heat the tobacco leaves just enough to release flavor but does not ignite the tobacco leaves. Normally, the traditional cigarette will generate many harmful substances at the high temperature of 350° C. to 1000° C., while most of the low-temperature heated cigarettes are used below 300° C., which greatly reduces the harmful substances in first-hand smoke and second-hand smoke.

### SUMMARY

What is needed, therefore, is to provide an aerosol-generating device and an aerosol-generating system.

An aerosol-generating device including:
a housing defining an accommodating cavity capable of accommodating an aerosol-generating article; and
a magnetic element disposed in the accommodating cavity and capable of generating magnetic attraction or magnetic repulsion to the aerosol-generating article to draw or push the aerosol-generating article towards a predetermined location of the accommodating cavity or in a predetermined direction.

In an embodiment, the aerosol-generating device further includes a controller capable of changing polarity of magnetic poles of the magnetic element, so that the magnetic element generates the magnetic attraction or the magnetic repulsion to the aerosol-generating article.

In an embodiment, the magnetic element is an electromagnet.

In an embodiment, a surface of the housing defines an opening communicating with an end of the accommodating cavity, and the magnetic element is disposed at another end, away from the opening, of the accommodating cavity.

In an embodiment, the housing includes a sidewall and a bottom wall defining the accommodating cavity, the bottom wall is opposite to the opening, and the magnetic element is disposed at an end, adjacent to the bottom wall, of the sidewall or is disposed adjacent to the bottom wall.

In an embodiment, the aerosol-generating device further includes a first device-electrode, wherein the first device-electrode is configured to be electrically connected to an electric heating member of the aerosol-generating article, the first device-electrode is exposed in the accommodating cavity, and the magnetic element constitutes at least a part of the first device-electrode.

In an embodiment, the first device-electrode is an annular structure disposed along a circumferential direction of the sidewall; or the first device-electrode includes a plurality of magnetic sub-electrodes, and the plurality of magnetic sub-electrodes are aligned along the circumferential direction of the sidewall.

In an embodiment, the first device-electrode is a composite electrode including the magnetic element and a conducting element capable of conducting electricity.

In an embodiment, the aerosol-generating device further includes a controller and a second device-electrode, wherein the second device-electrode is configured to be electrically connected to the electric heating member of the aerosol-generating article, the second device-electrode includes an electromagnet, and the controller is configured to control magnitude of the magnetic attraction or the magnetic repulsion generated by the second device-electrode and applied on the aerosol-generating article.

In an embodiment, the second device-electrode is a composite electrode including the electromagnet and a conducting element capable of conducting electricity.

In an embodiment, the aerosol-generating device further includes a detector configured to detect a position of the aerosol-generating article in the accommodating cavity, and the controller is configured to determine the magnitude of the magnetic attraction or the magnetic repulsion generated by the second device-electrode on the basis of the position of the aerosol-generating article in the accommodating cavity.

In an embodiment, a surface of the housing defines an opening communicating with the accommodating cavity, and the second device-electrode is disposed at an end, adjacent to the opening, of the accommodating cavity; on the condition that no aerosol-generating article disposed in the accommodating cavity is detected by the detector, the controller controls an electric current conducted in the electromagnet to be turned off; on the condition that any aerosol-generating article disposed in the accommodating cavity is detected by the detector, the controller controls the electric current conducted in the electromagnet to be turned on.

In an embodiment, the aerosol-generating device further includes a second device-electrode, the first device-electrode and the second device-electrode both extend along an axial direction of the accommodating cavity; either or both of the first device-electrode and the second device-electrode are composite electrodes each including a magnet and a conducting element capable of conducting electricity.

In an embodiment, the aerosol-generating device includes at least two magnetic elements, and the at least two magnetic elements are both electromagnets configured to be conducted with electric currents in sequence to generate magnetic attraction or magnetic repulsion to the aerosol-generating article, thereby drawing or pushing the aerosol-generating article towards the predetermined location of the accommodating cavity or in the predetermined direction.

In an embodiment, the magnetic element is capable of generating the magnetic attraction to the aerosol-generating article to draw the aerosol-generating article to a bottom of the accommodating cavity.

In an embodiment, the aerosol-generating device further includes a detector configured to detect whether the aerosol-generating article is in the accommodating cavity, and/or detect the position of the aerosol-generating article in the accommodating cavity.

An aerosol-generating system including the aerosol-generating device and the aerosol-generating article, wherein the aerosol-generating article includes an element that is capable of being attracted by the magnetic attraction or repelled by the magnetic repulsion.

In an embodiment, the aerosol-generating article includes an electrical conducting material disposed on an outer surface of the aerosol-generating article and/or disposed in the aerosol-generating article, and the electrical conducting material is the element that is capable of being attracted by the magnetic attraction or repelled by the magnetic repulsion.

In an embodiment, the aerosol-generating article includes:
a smoking material configured to generate aerosol; and
an electric heating member capable of heating the smoking material,
wherein the electric heating member is the element that is capable of being attracted by the magnetic attraction or repelled by the magnetic repulsion.

In an embodiment, the aerosol-generating article includes:
a smoking material configured to generate aerosol;
an electric heating member capable of heating the smoking material; and
an article-electrode electrically connected to the electric heating member,
wherein the article-electrode is the element that is capable of being attracted by the magnetic attraction or repelled by the magnetic repulsion.

In an embodiment, the element that is capable of being attracted by the magnetic attraction or repelled by the magnetic repulsion includes at least one of a permanent magnet and a soft magnetic material.

Compared with conventional electronic cigarettes and low-temperature heated cigarettes, the aerosol-generating device of the present application generates the magnetic attraction or the magnetic repulsion to the aerosol-generating article to draw or push the aerosol-generating article to the predetermined location of the accommodating cavity of the aerosol-generating device, so that the aerosol-generating article is fixed at a correct location in the accommodating cavity, and the aerosol-generating device can effectively heat or provide electrical energy to the aerosol-generating article.

### BRIEF DESCRIPTION OF THE DRAWINGS

FIG. 1 is a schematic structural view of an aerosol-generating system according to an embodiment of the present application.

FIG. 2 is a schematic structural view of an aerosol-generating article according to an embodiment of the present application.

FIG. 3 is a schematic sectional view of the aerosol-generating system along the line I-I in FIG. 1.

FIG. 4 is a schematic view of a connection relationship of an aerosol-generating device according to an embodiment of the present application.

FIG. 5 is a schematic sectional view of the aerosol-generating device along the line II-II in FIG. 1.

FIG. 6 is a schematic cross-sectional view of an aerosol-generating system according to another embodiment of the present application.

FIG. 7 is a schematic longitudinal sectional view of an aerosol-generating system according to another embodiment of the present application.

FIG. 8 is a schematic structural view of an aerosol-generating article according to another embodiment of the present application.

FIG. 9 is a schematic longitudinal sectional view of an aerosol-generating system according to another embodiment of the present application.

FIG. 10 is a schematic cross-sectional view of an aerosol-generating device according to another embodiment of the present application.

### DETAILED DESCRIPTION

The present application will now be described in detail with reference to the accompanying drawings and embodiments in order to make the objects, technical solutions, and advantages of the present application more clear. It should be understood that the specific embodiments described herein are only for explaining the application, and not intended to limit the present application.

It should be noted that an element, when referred to as being “fixed” or “connected” to another element, may be directly fixed or connected to the other element or via an intermediate element. Rather when an element is referred to as being “directly” fixed or connected to another element, there is no intermediate element. Such terms as “vertical”, “horizontal”, “left”, “right” and the like used herein are for illustrative purposes only. The drawings are not necessarily drawn to scale, and various parts are drawn for better illustration of the embodiments.

In the embodiments of the present application, the term “smoking material” refers to a smoke-generating material, which is a material that can release flavor and/or nicotine and/or smoke when heated or burned, that is, a material that can be atomized, that is, an aerosol-generating material. The smoking material can be in a solid, semi-solid, or liquid state. In considerations of air permeability, assembly, manufacture, etc., the solid smoking material is often processed into thin sheets, so is often called “sheets”. Shredded sheets are also called smoking cuts. The smoking material mentioned in the embodiments of the present application can be natural or synthetic smoking liquid, smoking oil, smoking glue, smoking paste, smoking cuts, tobacco leaves, etc. In an example, the synthetic smoking material contains glycerin, propylene glycol, nicotine, etc. The smoking liquid is in a liquid state, the smoking oil is oily, the smoking gel is gelatinous, and the smoking paste is creamy. The smoking cuts include natural, synthetic, or extracted and processed smoking cuts. The tobacco leaves include natural, synthetic, or extracted and processed tobacco leaves. The smoking material can be heated in a form sealed by other substances, such as when stored in thermally degradable packaging, e.g., in microcapsules. After the smoking material is heated, prescribed volatile substances are released from the degraded or porous sealed packaging.

In the embodiments of the present application, the smoking material may or may not contain nicotine. The smoking material containing nicotine can include at least one of smoking liquid, smoking oil, smoking glue, smoking paste, smoking cuts, tobacco leaves, and the like made from nicotine-containing materials and natural tobacco leaf products. The smoking liquid is in a liquid state, the smoking oil is oily, the smoking gel is gelatinous, and the smoking paste is creamy. The smoking cuts include natural, synthetic, or extracted and processed smoking cuts. The tobacco leaves include natural, synthetic, or extracted and processed tobacco leaves. The smoking material containing no nicotine mainly includes a flavor substance, such as a spice, which can be atomized to simulate the smoking process and assist to quit smoking. In an embodiment, the spice is peppermint oil. The smoking material can also include other additives, such as glycerin and/or propylene glycol.

In the embodiments of the present application, the term “aerosol-generating article” refers to a product, e.g., a cigarette, a cartridge, or a smoking stick, containing the smoking material and being capable of generating an aerosol, e.g., smoke or mist, by heating. In an embodiment, the aerosol-generating article is a disposable product. The aerosol-generating article itself cannot provide electrical energy.

In the embodiments of the present application, the term “aerosol-generating device” refers to a device, e.g., a smoking device, configured to provide electrical energy to an aerosol-generating article.

In the embodiments of the application, the term “electric heating member” refers to an element that converts electrical energy provided by the aerosol-generating device into thermal energy and can be disposed in the aerosol-generating device or in the aerosol-generating article. In an embodiment, the electric heating member is disposed in the aerosol-generating article.

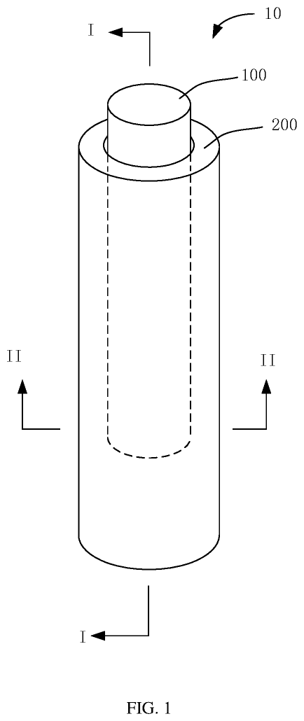

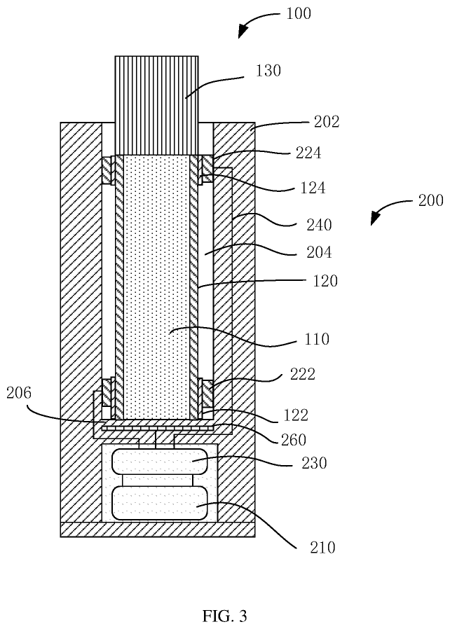

Referring to FIG. 1 to FIG. 3, an embodiment of the present application provides an aerosol-generating system 10 including an aerosol-generating article 100 and an aerosol-generating device 200. The aerosol-generating device 200 includes a housing and a magnetic element 260. The housing defines an accommodating cavity 204 capable of accommodating the aerosol-generating article 100. The magnetic element 260 is disposed in the accommodating cavity 204. The aerosol-generating article 100 is disposed in the accommodating cavity 204 when in use. The magnetic element 260 is capable of generating magnetic attraction or magnetic repulsion to the aerosol-generating article 100 to draw or push the aerosol-generating article 100 towards a predetermined location of the accommodating cavity 204 or in a predetermined direction, such as to reach the bottom of the accommodating cavity 204, an electrical connection port, etc. The aerosol-generating article 100 includes a smoking material 110 capable of generating aerosol and correspondingly includes an element that is capable of being attracted by the magnetic attraction or repelled by the magnetic repulsion. For another example, the predetermined direction is the direction along which the aerosol-generating article 100 enters the accommodating cavity 204, or the direction along which the aerosol-generating article 100 exits the accommodating cavity 204.

The aerosol-generating device 200 generates the magnetic attraction or the magnetic repulsion to the aerosol-generating article 100 to draw or push the aerosol-generating article 100 to the predetermined location of the accommodating cavity 204 of the aerosol-generating device 200, so that the aerosol-generating article 100 is fixed at a correct location in the accommodating cavity 204, and the aerosol-generating device 200 can effectively heat or provide electrical energy to the aerosol-generating article 100.

In an embodiment, a surface of the housing of the aerosol-generating device 200 defines an opening communicating with the accommodating cavity 204, so that the aerosol-generating article 100 can be inserted into the accommodating cavity 204 through the opening. The magnetic element 260 is disposed at an end, away from the opening, of the accommodating cavity 204. The aerosol-generating article 100 includes an air inflow end and an air outflow end. The element that is capable of being attracted by the magnetic attraction can be disposed adjacent to the air inflow end, so that the air inflow end of the aerosol-generating article 100 can be attracted by the magnetic element 260 disposed at the end, away from the opening, of the accommodating cavity 204 and drawn to the bottom of the accommodating cavity 204 of the aerosol-generating device 200.

Specifically, the housing can include a tubular sidewall 202 and a bottom wall 206, which are joined together to form a cup-shaped structure and capable of defining the accommodating cavity 204. The bottom wall 206 is opposite to the opening. The magnetic element 260 is disposed at an end, adjacent to the bottom wall 206, of the tubular sidewall 202 or is disposed adjacent to the bottom wall 206. In the aerosol-generating article 100, the element that is capable of being attracted by the magnetic attraction or repelled by the magnetic repulsion can be a separately arranged element, such as a sheet member or an annular member disposed at the air inflow end of the aerosol-generating article 100, or can be powder particles uniformly mixed with the smoking material 110. In an embodiment, the element that is capable of being attracted by the magnetic attraction or repelled by the magnetic repulsion can also function as another functional element of the aerosol-generating article 100, or the element is a part of the functional element, such as at least a part of an electric heating member 120 and/or a first article-electrode 122 and/or a second article-electrode 124. The material of the element that is capable of being attracted by the magnetic attraction or repelled by the magnetic repulsion can be selected from at least one of a ferromagnetic material and a ferrimagnetic material. The ferromagnetic and ferrimagnetic materials can be selected from, but not limited to, at least one of iron, cobalt, nickel, iron oxide (Fe₂O₃), iron (II,III) oxide (Fe₃O₄), chromium oxide (CrO₂), aluminum-nickel-cobalt alloy, samarium-cobalt alloy, and neodymium-iron-boron alloy. In an embodiment, the material of the element that is capable of being attracted by the magnetic attraction can be selected from soft magnetic materials. The soft magnetic materials can include at least one of an amorphous soft magnetic alloy and a nanocrystalline soft magnetic alloy, for example, iron-based, cobalt-based, iron-nickel-based, or iron-cobalt-nickel-based nanocrystalline soft magnetic alloys, or iron-based, cobalt-based, iron-nickel-based, or iron-cobalt-nickel-based amorphous soft magnetic alloys. In an embodiment, the aerosol-generating article 100 further includes a filter 130 disposed at the air outflow end. When the aerosol-generating article 100 is disposed in the accommodating cavity 204 of the aerosol-generating device 200, the filter 130 can be exposed from the opening for a user to inhale aerosol.

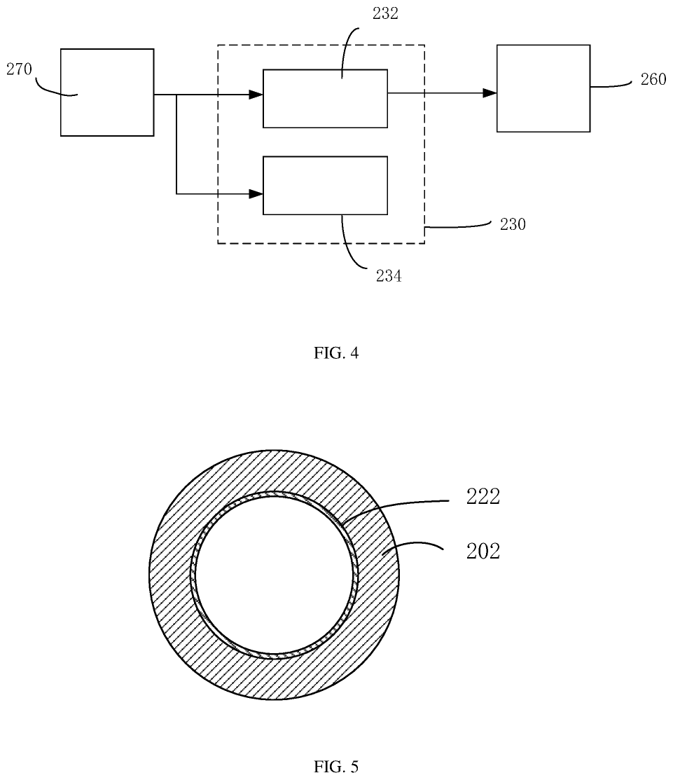

Referring also to FIG. 4, in an embodiment, the aerosol-generating device 200 can further include a controller 230. The controller 230 can include a magnetic element controller 232 configured to control polarity of magnetic poles and/or the magnetic field strength of the magnetic element 260. In an embodiment, the magnetic element 260 is an electromagnet to generate magnetic field by conducting an electric current through a coil. The magnetic element controller 232 changes the polarity of the magnetic poles of the magnetic element 260 by changing the direction of the electric current, and changes the magnetic field strength of the magnetic element 260 by changing the magnitude of the electric current.

In an embodiment, in the aerosol-generating article 100, the element that is capable of being attracted by the magnetic attraction or repelled by the magnetic repulsion itself is a magnetic member, such as a permanent magnet. By changing the polarity of the magnetic poles of the magnetic element 260, the direction of the force applied on the aerosol-generating article 100 can be changed. When the aerosol-generating article 100 needs to be drawn to the bottom of the accommodating cavity 204 of the aerosol-generating device 200, the magnetic element controller 232 controls the polarity of the magnetic poles of the magnetic element 260 to generate a force that attracts the aerosol-generating article 100. When the aerosol-generating article 100 needs to be discharged from the accommodating cavity 204, for example, after the aerosol-generating article 100 is used, the magnetic element controller 232 changes the polarity of the magnetic poles of the magnetic element 260 to generate a force that repels the aerosol-generating article 100, so that the aerosol-generating article 100 can be pushed out easily from the aerosol-generating device 200. In an embodiment, when an abnormal current state, such as a short-circuit state, is detected, or when an over-high temperature is detected, the magnetic element controller 232 controls the magnetic element to generate a magnetic repulsive force on the aerosol-generating article 100 to displace the aerosol-generating article 100 away from a specific point, such as a short-circuit point or an electrical contact point, of the aerosol-generating device 200 or to avoid an over-tight contact therewith.

In an embodiment, the aerosol-generating device 200 includes at least two magnetic elements 260, and the magnetic elements 260 are both electromagnets. The magnetic element controller 232 sequentially conducts electric currents in the electromagnets, which sequentially generate the magnetic attraction or the magnetic repulsion to the aerosol-generating article 100 and draw or push the aerosol-generating article 100 to the predetermined location of the accommodating cavity 204.

In an embodiment, the aerosol-generating article 100 can include an electric heating member 120. The electric heating member 120 is disposed adjacent to the smoking material 110 and is capable of converting electrical energy into thermal energy to heat the smoking material 110. The electric heating member 120 can cover the smoking material 110, be covered by the smoking material 110, and/or be disposed in the smoking material 110. As a part of the aerosol-generating article 100, the electric heating member 120 will be removed out with the aerosol-generating article 100 from the aerosol-generating device 200 after the aerosol-generating article 100 is used, which avoids accumulation of tar and other pollutants in the aerosol-generating device 200 during repetitive use of the same electric heating member 120 in heating different aerosol-generating articles 100. In addition, by having the electric heating member 120 as a part of the aerosol-generating article 100, the smoking material 110 and the electric heating member 120 can realize better and sufficient contact with each other during the manufacture of the aerosol-generating article 100, thereby improving heating efficiency. The electric heating member 120 can have varied shapes and structures and does not need to have a high mechanical strength to withstand the pressure in repeatedly inserting into smoking materials 110. Correspondingly, the aerosol-generating device 200 can include a device-electrode disposed in the accommodating cavity 204. The device-electrode is capable of supplying electric power to the electric heating member 120. The device-electrode can be, for example, a first device-electrode 222 and a second device-electrode 224. When the aerosol-generating article 100 is inserted into the accommodating cavity 204, the first device-electrode 222 and the second device-electrode 224 are electrically and respectively connected to the electric heating member 120, so that the electric current is supplied to the electric heating member 120 to generate heat and heat the adjacent smoking material 110. The aerosol-generating device 200 can further include a power supply member 210 for providing direct current, such as a battery or a socket configured to be connected to an external power source. The positive and negative electrodes of the power supply member 210 are electrically and respectively connected to the first device-electrode 222 and the second device-electrode 224 through wires 240. The controller 230 can include a power supply controller 234. The power supply controller 234 is configured to control the voltage and/or current provided to the device-electrodes from the power supply member 210, so as to be functionalized as a switch and/or a temperature regulator. The power supply member 210 and the controller 230 can be disposed in the housing.

The locations of the first device-electrode 222 and the second device-electrode 224 are adaptive for electrically connecting the device-electrodes to the electric heating member 120 when the aerosol-generating article 100 is inserted into the accommodating cavity 204. In an embodiment, the first device-electrode 222 and the second device-electrode 224 are respectively and electrically connected to two ends of the electric heating member 120, so that the electric current flows uniformly through the entire electric heating member 120 and the heat generation in the electric heating member 120 is uniform. In an embodiment, the first device-electrode 222 and the second device-electrode 224 are respectively disposed at two ends of the accommodating cavity 204 and exposed to the outside from the sidewall 202. The first device-electrode 222 is disposed at the end, adjacent to the bottom wall, of the sidewall 202, and the second device-electrode 224 is disposed at the end, adjacent to the opening, of the sidewall 202.

In an embodiment, the electric heating member 120 is a quasi two-dimensional structure, such as a sheet, a layer, or a film, thereby having a relatively large surface area. For example, the electric heating member 120 can be a foil or a film made of an electrical conducting material, such as metal, alloy, or carbon material; the electric heating member 120 can be, for example, a metal foil, an alloy foil, a carbon paper, a carbon fiber paper, a carbon fiber film, a carbon nanotube film, etc. The material of the metal foil and the alloy foil can be selected from, but not limited to, one or more of gold, silver, copper, aluminum, nickel, chromium, iron, stainless steel, nickel-chromium alloy, iron-chromium-aluminum alloy, palladium alloy, and the like. In addition, the material of the quasi two-dimensional electric heating member 120 can also be a composite material obtained by compositing the metal, alloy, or carbon material with other inorganic or organic materials, such as ceramic particles, glass fibers, polymers, and the like. A thickness of the quasi two-dimensional electric heating member 120 can be 1 nanometer to 1 millimeter, in an embodiment, can be 500 nanometers to 500 micrometers, and in another embodiment, can be 1 micrometer to 30 micrometers.

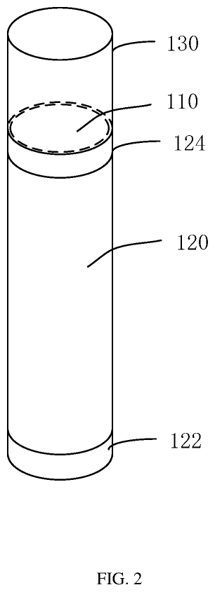

In the embodiment of FIG. 2, the quasi two-dimensional electric heating member 120 is wrapped around the periphery of the entire smoking material 110 as a whole to form a tubular structure. The electric heating member 120 itself can also function as an overwrap paper or a supporting outer tube, not only electrically heating the smoking material 110 but also overall wrapping, supporting, and accommodating the smoking material 110. In another embodiment, the quasi two-dimensional electric heating member 120 can be in a spiral shape and disposed in the smoking material 110. For example, the aerosol-generating article 100 can be manufactured by a method similar to that for traditional cigarettes. That is, the smoking material 110 is firstly formed into a smoking material sheet 110, and the quasi two-dimensional electric heating member 120 is stacked on the smoking material sheet 110 to form a laminated structure. Then, the laminated structure is rolled up to form a rod or stick to obtain the electric heating member 120 with the spiral shape in the smoking material 110.

It can be understood that the electric heating member 120 is not limited to the quasi two-dimensional structure. For example, the electric heating member 120 can include one or more quasi one-dimensional structures, such as heating rods, heating sticks, or heating wires. Alternatively, the electric heating member 120 includes an electric heating material dispersed in the smoking material 110. The electric heating material is in shape of, for example, powder, flakes, small particles, or short fibers. The electric heating material and the smoking material 110 are mixed together and connected to each other to form a conducting path, so that the electric current is more uniformly conducted to the inner portion of the aerosol-generating article 100, to uniformly heat the regional smoking material 110. The size of the electric heating material can be, for example, 10 nanometers to 5 millimeters. The electric heating material can be, for example, metal or alloy in shape of powder or shreds, or conductive carbon materials, such as carbon nanotubes, graphene sheets, carbon fibers, amorphous carbon, or graphite particles or powder.

The electric heating members 120 of above-described various forms can be combined with each other.

Theoretically, as long as the two ends of the electric heating member 120 are respectively connected to the first device-electrode 222 and the second device-electrode 224 of the aerosol-generating device 200, the electric heating member 120 can be supplied with electrical power, and the smoking material 110 can be electrical heated. To be better electrically connected to the first device-electrode 222 and second device-electrode 224 of the aerosol-generating device 200, the aerosol-generating article 100 can include article-electrodes, such as a first article-electrode 122 and a second article-electrode 124. The material of the article-electrodes can have greater conductivity than the electric heating member 120. The article-electrodes can be in shape of a layer, a film, a wire, a sheet, or a block. In an embodiment, the first article-electrode 122 and the second article-electrode 124 are spaced from each other and disposed at two ends of the electric heating member 120. The article-electrodes and the electric heating member 120 are electrically connected in the aerosol-generating article 100. For example, the article-electrodes can be respectively welded to the electric heating member 120, fixedly connected to the electric heating member 120 by snap-fit structures, or bonded to the electric heating member 120 by conductive glue. Otherwise, the article-electrodes can also be formed on the surface of the electric heating member 120 through film plating, spray coating, or printing. The article-electrodes are exposed from the surface of the aerosol-generating article 100, and in an embodiment, are exposed outside from a sidewall of the aerosol-generating article 100, thereby forming an electrical contact with the device-electrodes disposed on the tubular sidewall 202. The aerosol-generating device 200 can also include a separate non-conductive cigarette paper (not shown), which is wrapped around the periphery of both the electric heating member 120 and the smoking material 110 as a whole. The article-electrodes of the aerosol-generating article 100 can be directly exposed from the overwrap paper, or otherwise the user can manually tear off the overwrap paper covered on the article-electrodes in use of the aerosol-generating article 100.

In order to easily cause the device-electrodes of the aerosol-generating device 200 and the article-electrodes of the aerosol-generating article 100 to be in contact with each other to achieve the electrical connection, the locations of the device-electrodes in the accommodating cavity 204 and the locations of the article-electrodes in the aerosol-generating article 100 are corresponded to each other, so that the device-electrodes directly face the article-electrodes when the aerosol-generating article 100 is disposed in the aerosol-generating device 200. In an embodiment, the size (e.g., the radial size) of the aerosol-generating article 100 matches the size (e.g., the radial size) of the accommodating cavity 204, so that the device-electrodes and the article-electrodes can be in contact with each other.

In an embodiment, the aerosol-generating article 100 is a column structure, and the first article-electrode 122 and the second article-electrode 124 are annular structures disposed along a circumferential direction of the column structure. The electric heating member 120 is a tubular structure. The first article electrode 122 and the second article electrode 124 are respectively disposed at two ends of the tubular structure in the axial direction and extended circumferentially around the aerosol-generating article 100, so that every location of the electric heating member 120 is evenly supplied with the electric current to make the temperature uniform. Referring to FIG. 5, correspondingly, the accommodating cavity 204 is a column structure, and the device-electrodes includes an annular-shaped first device-electrode 222 and an annular-shaped second device-electrode 224, which are circumferentially disposed on the inner surface of the sidewall 202. The locations of the first device-electrode 222 and the second device-electrode 224 in the axial direction of the accommodating cavity 204 respectively correspond to the locations of the first article-electrode 122 and the second article-electrode 124, so that the first device-electrode 222 directly faces the first article-electrode 122, and the second device-electrode 224 directly faces the second article-electrode 124 when the aerosol-generating article 100 is disposed in the aerosol-generating device 200. The outer diameters of the annular-shaped first article-electrode 122 and the annular-shaped second-article electrode 124 are equal to or slightly smaller than the inner diameters of the annular-shaped first device-electrode 222 and the annular-shaped second device-electrode 224, so that the first article-electrode 122 and the second article-electrode 124 can be respectively surrounded by the first device-electrode 222 and the second device-electrode 224.

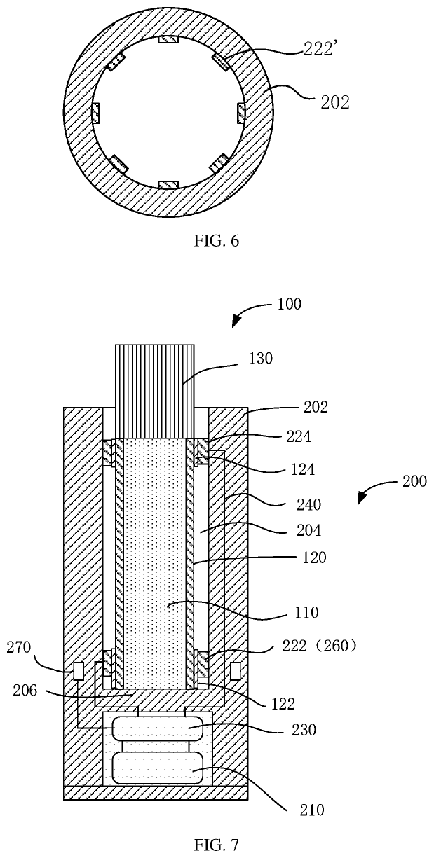

Referring to FIG. 6, in another embodiment, each device-electrode includes a plurality of sub-electrodes 222′ aligned along the circumferential direction on the inner surface of the sidewall 202. The plurality of sub-electrodes 222′ can be disposed at intervals, for example, at equal intervals. Compared with the integrated annular-shaped electrode which is matched in size with the tubular sidewall 202, the annular structure cooperatively formed by the plurality of sub-electrodes 222′ requires relatively low dimensional accuracy and is relatively easy to manufacture. In an embodiment, the sub-electrodes 222′ in the same device-electrode are all connected to the same voltage source and have the same potential.

In the aerosol-generating article 100, at least one selected from the electric heating member 120, the first article-electrode 122, and the second article-electrode 124 can be ferromagnetic or ferrimagnetic and can be attracted by the magnetic element 260 of the aerosol-generating device 200. In an embodiment, the first article-electrode 122 adjacent to the air inflow end is ferromagnetic or ferrimagnetic.

The magnetic element 260 of the aerosol-generating device 200 can be a separately arranged element. Referring to FIG. 7, in an embodiment, the magnetic element 260 of the aerosol-generating device 200 is also at least a part of the device-electrode that is configured to be electrically connected to the electric heating member 120 of the aerosol-generating article 100. The magnetic element 260 can be at least a part of the first device-electrode 222 adjacent to the bottom wall 206. In an embodiment, the first device-electrode 222 is a composite electrode, which includes the magnetic element 260 and a conducting element capable of conducting electricity. The magnetic element 260 can be disposed around the conducting element or stacked with the conducting element. The material of the conducting element can have greater electrical conductivity compared to the magnetic element 260. The material of the magnetic element 260 can have greater magnetic permeability, higher Curie temperature, and higher remanence compared to the conducting element.

In an embodiment, both the first device-electrode 222 and the second device-electrode 224 are magnetic electrodes, which can generate magnetic force to attract the electric heating member 120 and/or the article-electrodes, so that the device-electrodes are in tight and stable contact with the electric heating member 120 and/or the article-electrodes , and the first device-electrode 222 and the second device-electrode 224 are sufficiently electrically connected to the electric heating member 120, avoiding the problems of poor electrical connection and overlarge local contact resistance caused by the installation of the aerosol-generating article 100 by the user or caused by the deformation of the aerosol-generating article 100 after a period of use. Since the magnetic electrodes need to be in contact with the article-electrodes or the electric heating member 120 when in use, the magnetic electrodes need to withstand relatively high temperatures. In an embodiment, the magnetic electrodes can generate the magnetic force at 200° C. to 400° C. In an embodiment, the Curie temperature of the material of the magnetic electrodes is greater than 400° C. The magnetic electrode can be a permanent magnet or an electromagnet. In an embodiment, the first device-electrode 222 and/or the second device-electrode 224 include electromagnets.

In an embodiment, the second device-electrode 224 is a composite electrode, which includes a magnet and a conducting element capable of conducting electricity. The magnet can be arranged around the conducting element or stacked with the conducting element. The material of the conducting element can have greater electrical conductivity compared to the magnet, and the material of the magnet can have greater magnetic permeability, higher Curie temperature, and higher remanence compared to the conducting element. In an embodiment, the magnet in the second device-electrode 224 is an electromagnet.

In an embodiment, the magnetic element controller 232 of the controller 230 is configured to control the magnetic field strength of the second device-electrode 224 having magnetism. For example, the magnetic element controller 232 can be a switch for conducting electric current to the electromagnet. Before inserting the aerosol-generating article 100 into the accommodating cavity 204, the user can manually turn off the switch to avoid affecting the correct setting of the aerosol-generating article 100 in the accommodating cavity 204; after inserting the aerosol-generating article 100 into the accommodating cavity 204, the user can manually turn on the switch to cause the second device-electrode 224 to generate magnetic attraction to the electric heating member 120 or the second article-electrode 124 to achieve stable electrical connection.

In an embodiment, the aerosol-generating device 200 further includes a detector 270 configured to detect the position of the aerosol-generating article 100 in the accommodating cavity 204. The controller 230 is configured to determine the magnitude of the magnetic attraction or the magnetic repulsion generated by the second device-electrode 224 on the basis of the position of the aerosol-generating article 100 in the accommodating cavity 204. For example, the detector 270 can include an inductance coil arranged at the bottom of the accommodating cavity 204. When the aerosol-generating article 100 arrives in the accommodating cavity 204, it can affect the electric current in the inductance coil, so that the detector 270 can detect whether the aerosol-generating article 100 is in the accommodating cavity 204. The detector 270 can include an inductance coil disposed at the bottom of the accommodating cavity 204. When the aerosol-generating article 100 reaches the bottom of the accommodating cavity 204, the aerosol-generating article 100 affects the electric current in the inductance coil, so that the detector 270 determines that the aerosol-generating article 100 has reached a correct position. When the detector 270 determines that the aerosol-generating article 100 reaches the bottom of the accommodating cavity 204, the detector 270 sends a detection signal to the controller 230. The magnetic element controller 232 conducts the electric current in the electromagnet of the second device-electrode 224 according to the detection signal, so as to generate the magnetic attraction; otherwise, the magnetic element controller 232 turns off the electric current to avoid affecting the position of the aerosol-generating article 100 during the process of inserting the aerosol-generating article 100 into the accommodating cavity 204. The detector 270 can also detect whether the electrical connection between the aerosol-generating article 100 and the aerosol-generating device 200 is in a normal state, for example, detect whether there is a short circuit in the connection. The controller 230 controls the magnitude and/or direction of the magnetic force generated by the magnetic element 260 according to whether the electrical connection is in abnormal state. For example, when an abnormal current state, such as a short circuit, is detected, the magnetic element controller 232 of the controller 230 controls the magnetic element 260 to generate a magnetic repulsive force on the aerosol-generating article 100 to make the aerosol-generating article 100 be away from a specific point, such as a short-circuit point, of the aerosol-generating device 200 or to avoid an over-tight contact therewith.

It can be understood that when the aerosol-generating device 200 includes a separately arranged magnetic element 260, and the first device-electrode 222 and the second device-electrode 224 are both magnetic electrodes, the first device-electrode 222 and the second device-electrode 224 can be simultaneously controlled to generate magnetic attraction or cancel the magnetic attraction.

In an embodiment, the power supply controller 234 can also receive the detection signal of the detector 270. When the aerosol-generating article 100 reaches the bottom of the accommodating cavity 204, the power supply controller 234 controls the power supply member 210 to automatically supply power to the device-electrodes by controlling the voltage and/or current of the power supply, or otherwise the voltage and/or current is turned off.

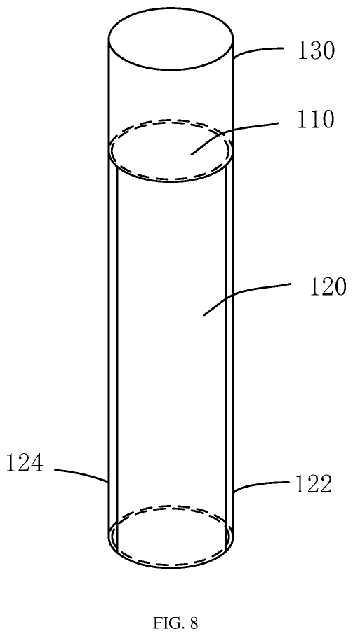

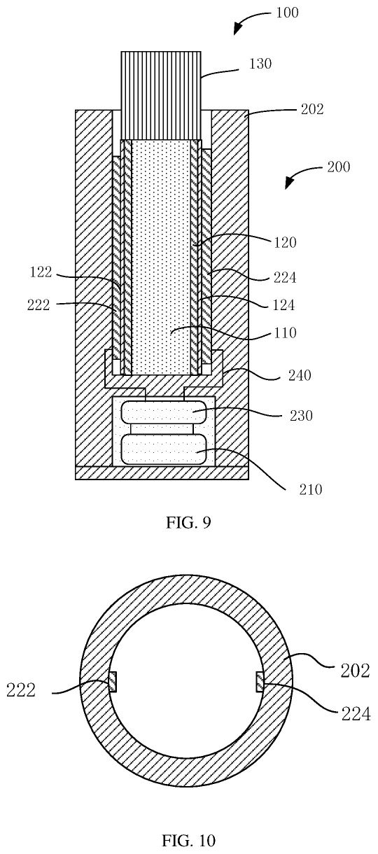

Referring to FIGS. 8 to 10, in an embodiment, the length directions of the first article-electrode 122 and the second article-electrode 124 of the aerosol-generating article 100 are parallel to the axial or longitudinal direction of the aerosol-generating article 100, so that the electric heating member 120 is electrically conducted along a circumferential direction thereof. The locations of the first article-electrode 122 and the second article-electrode 124 correspond to the locations of the first device-electrode 222 and the second device-electrode 224 of the aerosol-generating device 200 in a one-to-one manner. In an embodiment, the first article-electrode 122 and the second article-electrode 124 are spaced apart from each other and disposed on two ends, in the radial direction, of the tubular electric heating member 120; and the first device-electrode 222 and the second device-electrode 224 are spaced apart from each other and disposed on two ends, in the radial direction, of the tubular sidewall 202. The length directions of the first device-electrode 222 and the second device-electrode 224 are parallel to the axial direction of the tubular sidewall 202. At least one of the first device-electrode 222 and the second device-electrode 224 extending along the axial direction of the accommodating cavity 204 can include an electromagnet, for example, can be a composite electrode including the electromagnet and the conducting element. The magnetic attraction or the magnetic repulsion is generated between the device-electrodes and the article-electrodes, which can assist the positioning of the device-electrodes and the article-electrodes. When the user sets the aerosol-generating article 100 in the accommodating cavity 204 of the aerosol-generating device 200, the aerosol-generating article 100 can easily rotate due to the magnetic force to make the locations of the article-electrodes corresponded to the locations of the device-electrodes.

In an embodiment, the part of the aerosol-generating article 100 that is configured to be connected to the external power source is deformable; for example, the electric heating member 120 and/or the article-electrodes are deformable. In an embodiment, the deformable part that is configured to be connected to the external power source is the electrical conducting overwrap paper that wraps the smoking material 110. When the smoking material 110 in the aerosol-generating article 100 is heated for a period of time, as the substance volatilizes, the volume of the smoking material 110 will gradually decrease, which may easily cause a deformation of the aerosol-generating article 100 and make the part configured to be connected to the external power source deformed. The magnetic element 260 generates the magnetic attraction or the magnetic repulsion to the aerosol-generating article 100, in order to maintain the shape of the part of the aerosol-generating article 100, such that the part is maintained to be in connection with the external power source under the action of magnetic force.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art, without departing from the concept of the present application, various modifications and improvements can be made and all fall within the protection scope of the present application. Therefore, the patent protection of the present application shall be defined by the appended claims.

What is claimed is:

1. An aerosol-generating device, comprising:
a housing defining an accommodating cavity capable of accommodating an aerosol-generating article; and
a magnetic element disposed in the accommodating cavity and capable of generating magnetic attraction or magnetic repulsion to the aerosol-generating article to draw or push the aerosol-generating article towards a predetermined location of the accommodating cavity or in a predetermined direction.

2. The aerosol-generating device of claim 1, further comprising a controller capable of changing polarity of magnetic poles of the magnetic element, so that the magnetic element generates the magnetic attraction or the magnetic repulsion to the aerosol-generating article.

3. The aerosol-generating device of claim 2, wherein the magnetic element is an electromagnet.

4. The aerosol-generating device of claim 1, wherein a surface of the housing defines an opening communicating with an end of the accommodating cavity, and the magnetic element is disposed at another end, away from the opening, of the accommodating cavity.

5. The aerosol-generating device of claim 4, wherein the housing comprises a sidewall and a bottom wall defining the accommodating cavity, the bottom wall is opposite to the opening, and the magnetic element is disposed at an end, adjacent to the bottom wall, of the sidewall or is disposed adjacent to the bottom wall.

6. The aerosol-generating device of claim 1, further comprising a first device-electrode, wherein the first device-electrode is configured to be electrically connected to an electric heating member of the aerosol-generating article, the first device-electrode is exposed in the accommodating cavity, and the magnetic element constitutes at least a part of the first device-electrode.

7. The aerosol-generating device of claim 6, wherein the first device-electrode is an annular structure disposed along a circumferential direction of the sidewall; or the first device-electrode comprises a plurality of magnetic sub-electrodes, and the plurality of magnetic sub-electrodes are aligned along the circumferential direction of the sidewall.

8. The aerosol-generating device of claim 6, further comprising a controller and a second device-electrode, wherein the second device-electrode is configured to be electrically connected to the electric heating member of the aerosol-generating article, the second device-electrode comprises an electromagnet, and the controller is configured to control magnitude of the magnetic attraction or the magnetic repulsion generated by the second device-electrode and applied on the aerosol-generating article.

9. The aerosol-generating device of claim 8, wherein at least one of the first device-electrode and the second device-electrode is a composite electrode comprising the electromagnet and a conducting element capable of conducting electricity.

10. The aerosol-generating device of claim 8, further comprising a detector configured to detect a position of the aerosol-generating article in the accommodating cavity, and the controller is configured to determine the magnitude of the magnetic attraction or the magnetic repulsion generated by the second device-electrode on the basis of the position of the aerosol-generating article in the accommodating cavity.

11. The aerosol-generating device of claim 10, wherein a surface of the housing defines an opening communicating with the accommodating cavity, and the second device-electrode is disposed at an end, adjacent to the opening, of the accommodating cavity; on the condition that no aerosol-generating article disposed in the accommodating cavity is detected by the detector, the controller controls an electric current conducted in the electromagnet to be turned off; on the condition that any aerosol-generating article disposed in the accommodating cavity is detected by the detector, the controller controls the electric current conducted in the electromagnet to be turned on.

12. The aerosol-generating device of claim 6, further comprising a second device-electrode, the first device-electrode and the second device-electrode both extend along an axial direction of the accommodating cavity; either or both of the first device-electrode and the second device-electrode are composite electrodes each comprising a magnet and a conducting element capable of conducting electricity.

13. The aerosol-generating device of claim 1, comprising at least two magnetic elements, and the at least two magnetic elements are both electromagnets configured to be conducted with electric currents in sequence to generate the magnetic attraction or the magnetic repulsion to the aerosol-generating article to draw or push the aerosol-generating article towards the predetermined location of the accommodating cavity or in the predetermined direction.

14. The aerosol-generating device of claim 1, wherein the magnetic element is capable of generating a magnetic attraction to the aerosol-generating article to draw the aerosol-generating article to a bottom of the accommodating cavity.

15. The aerosol-generating device of claim 1, further comprising a detector configured to detect whether the aerosol-generating article is in the accommodating cavity and/or detect a position of the aerosol-generating article in the accommodating cavity.

16. An aerosol-generating system, comprising the aerosol-generating device of claim 1 and an aerosol-generating article, wherein the aerosol-generating article comprises an element that is capable of being attracted by the magnetic attraction or repelled by the magnetic repulsion.

17. The aerosol-generating system of claim 16, wherein the aerosol-generating article comprises an electrical conducting material disposed on an outer surface of the aerosol-generating article and/or disposed in the aerosol-generating article, and the electrical conducting material is the element that is capable of being attracted by the magnetic attraction or repelled by the magnetic repulsion.

18. The aerosol-generating system of claim 16, wherein the aerosol-generating article comprises:
a smoking material configured to generate aerosol; and
an electric heating member capable of heating the smoking material,
wherein the electric heating member is the element that is capable of being attracted by the magnetic attraction or repelled by the magnetic repulsion.

19. The aerosol-generating system of claim 16, wherein the aerosol-generating article comprises:
a smoking material configured to generate aerosol;
an electric heating member capable of heating the smoking material; and
an article-electrode electrically connected to the electric heating member,
wherein the article-electrode is the element that is capable of being attracted by the magnetic attraction or repelled by the magnetic repulsion.

20. The aerosol-generating system of claim 16, wherein the element that is capable of being attracted by the magnetic attraction or repelled by the magnetic repulsion comprises at least one of a permanent magnet and a soft magnetic material.
